(19) United States
(12) Patent Application Publication
(10) Pub. No.: US 2014/0049033 A1
(43) Pub. Date: Feb. 20, 2014

(54) COMPOSITE BOX FRAME

(71) Applicants: Justin Yee, Portland, OR (US); Maik Ziegler, Portland, OR (US)

(72) Inventors: Justin Yee, Portland, OR (US); Maik Ziegler, Portland, OR (US)

(73) Assignee: Daimler Trucks North America LLC

(21) Appl. No.: 13/588,815

(22) Filed: Aug. 17, 2012

(51) Int. Cl. B62D 21/02

(52) U.S. Cl. 280/797

(57) ABSTRACT

This disclosure relates to vehicle frame components that are comprised of composite materials. Vehicle frame component structures are disclosed that address the relative lack of the compressive strength of composites compared to conventional metal materials used in vehicle frames. One desirable frame structure is a box frame rail structure that is comprised of composite materials and that has an enhanced capacity to accommodate compressive loads. In addition, the disclosed box frame rail structures provide protective routing options for wiring and pneumatic plumbing.

### SUMMARY

This disclosure relates to vehicle frame components that are comprised of composite materials. Vehicle frame component structures are disclosed that address the relative lack of the compressive strength of composites compared to conventional metal materials used in vehicle frames. One desirable frame structure is a box frame rail structure that is comprised of composite materials and that has an enhanced capacity to accommodate compressive loads. In addition, the disclosed box frame rail structures provide protective routing options for wiring and pneumatic plumbing.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of a portion of an exemplary composite frame for use in vehicles, such as truck tractors and trailers.

FIG. 2 is an end view of the frame of FIG. 1.

FIG. 3 is an exploded perspective view of the frame of FIG. 1.

FIG. 4 is an exploded top view of the frame of FIG. 1.

FIG. 5 is an exploded end view of the frame of FIG. 1.

FIG. 6 is an exploded perspective view of exemplary inside supports and inserts of the frame of FIG. 1.

### DETAILED DESCRIPTION

Described herein are embodiments of a composite box frame for a vehicle. The following description is exemplary in nature and is not intended to limit the scope, applicability, or configuration of the invention in any way. Various changes to the described embodiments may be made in the function and arrangement of the elements described herein without departing from the scope of the invention.

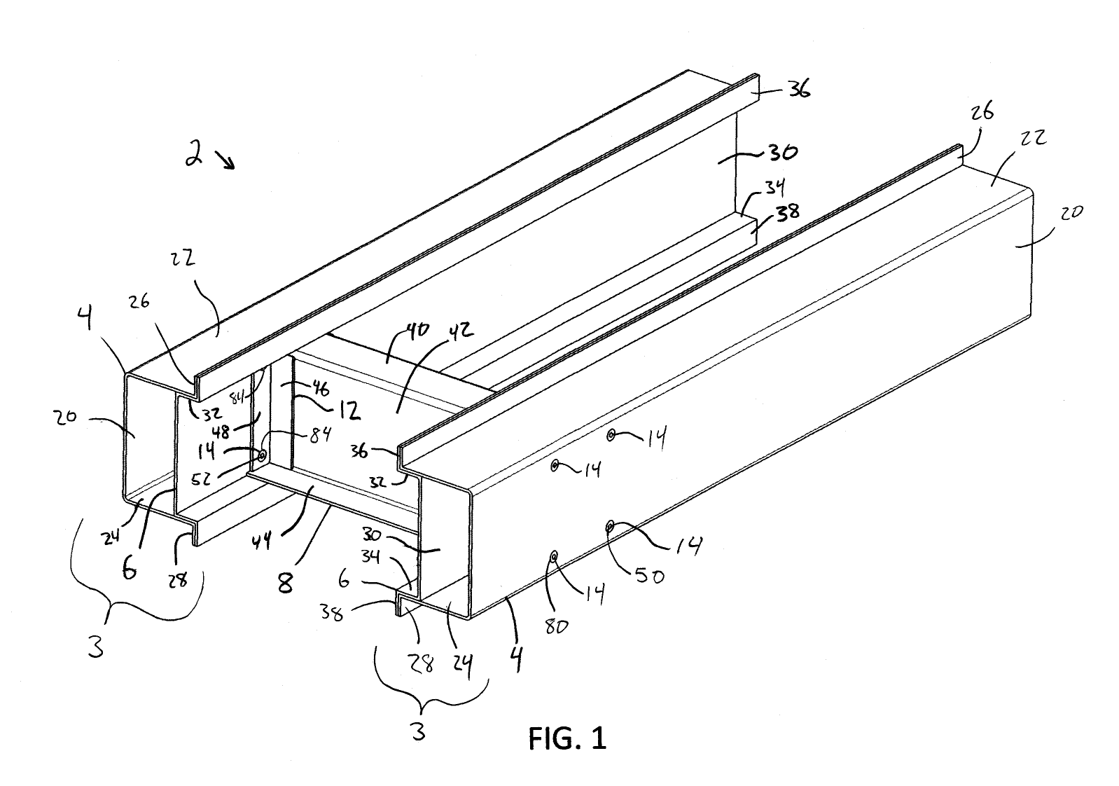

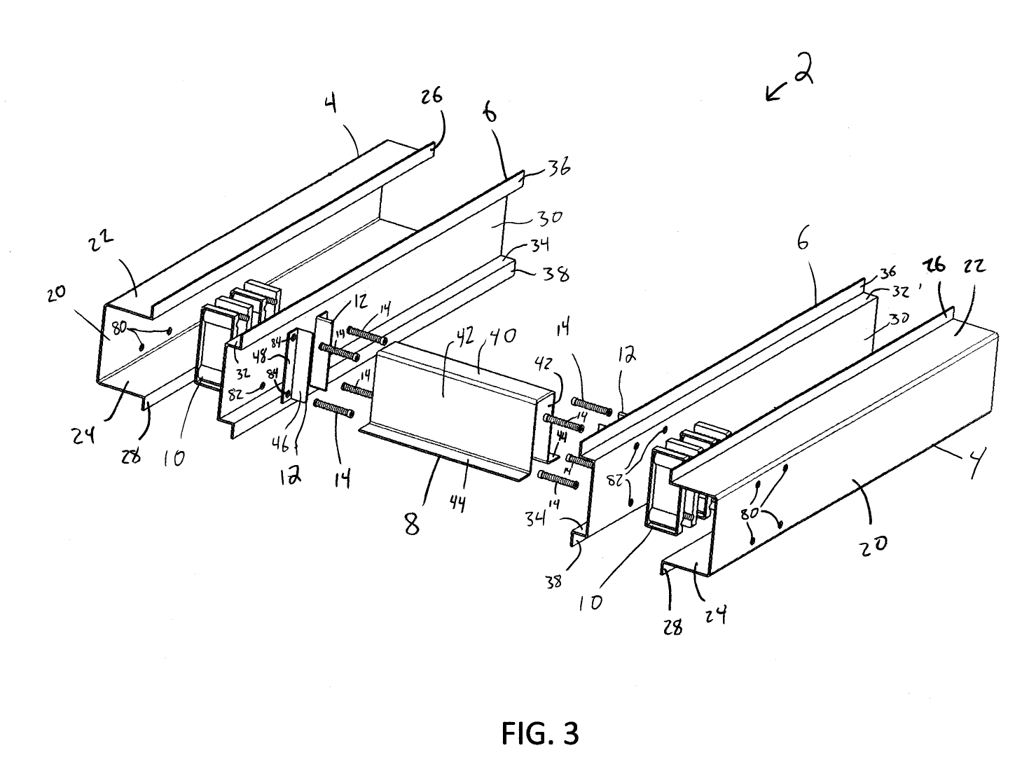

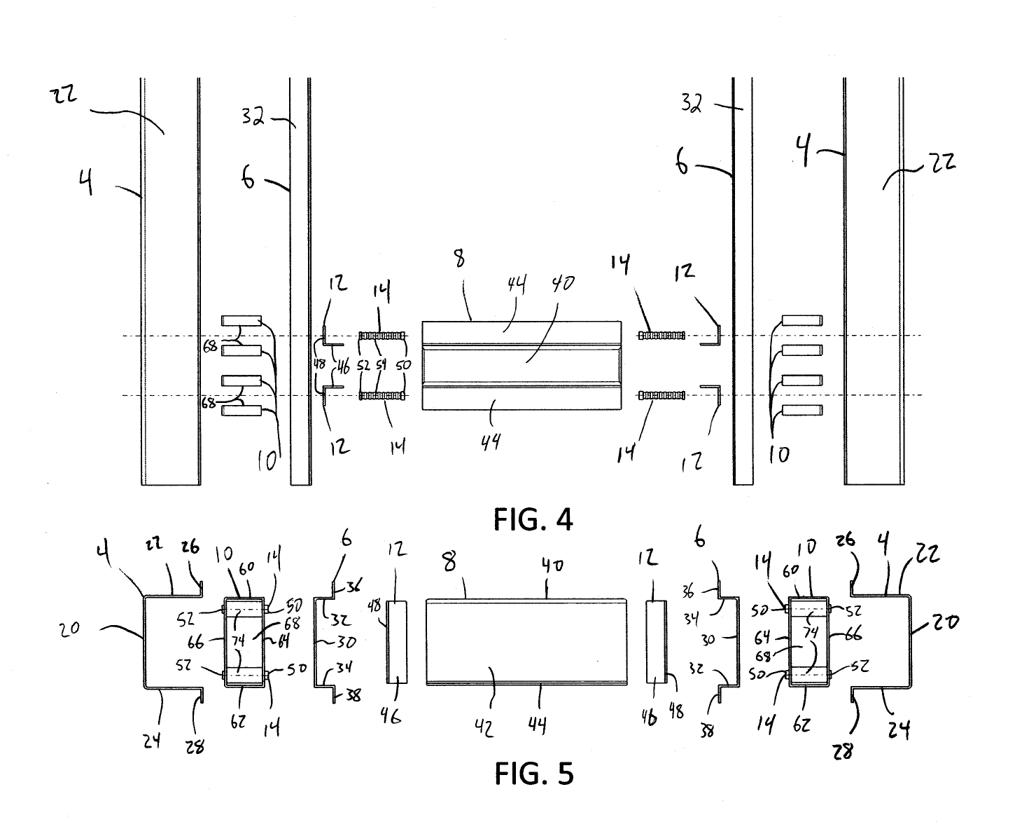

The vehicle frame 2 shown in FIGS. 1-6 comprises two longitudinally extending box frame rails 3, each comprising an outside rail section 4 and an inside rail section 6, and wherein the frame rails are connected together by at least one crossmember 8. The assembled frame rail sections desirably comprise box frame rail sections that define an internal passageway therebetween. The frame 2 can further comprise internal supports 10 and inserts 14 positioned within the box sections 3, and brackets 12 at the juncture of the crossmember 8 and the box sections.

Each outside rail section 4 can comprise an outer wall such as a vertically oriented outer side wall 20, a transverse upper wall such as a horizontally oriented top wall 22 extending inwardly from a top edge portion of the side wall 20, a transverse bottom wall such as a horizontally oriented bottom wall 24 extending inwardly from a bottom edge portion of the side wall 20, a top flange 26 extending upwardly from an inner edge portion of the top wall 22, and a bottom flange portion 28 extending downwardly from an inner edge portion of the bottom wall 24. The outside rail sections 4 can thus have a “hat” shaped cross-section. That is, the outside rail sections 4 can be described as generally U-shaped in cross section with a base and first and second leg portions with diverging distal end flange portions that are spaced from the base. Similarly, each frame rail 3 can further comprise an inner rail section 6 joined to the outer rail section 4. The inner rail section can comprise an upright inner wall such as a vertically oriented side wall 30 spaced from wall 20, a transverse upper wall such as a horizontally oriented top wall 32 extending inwardly from a top edge portion of the side wall 30, a transverse lower wall such as a horizontally oriented bottom wall 34 extending inwardly from a bottom edge portion of the side wall 30, a top flange portion 36 extending upwardly from an inner edge portion of the top wall 32, and a bottom flange portion 38 extending downwardly from an inner edge portion of the bottom wall 34. The inner rail sections 6 can have a shallower “hat” shaped cross-section compared to the outside rail sections 4. That is, the inner rail sections 6 can also be described as U-shaped in cross-section with a base and first and second leg portions with diverging distal end flange portions spaced from the base. The leg portions of the inner rail section are desirably shorter than the leg portions of the outer rail section so that a substantially enclosed box is provided between the outer and inner rail sections.

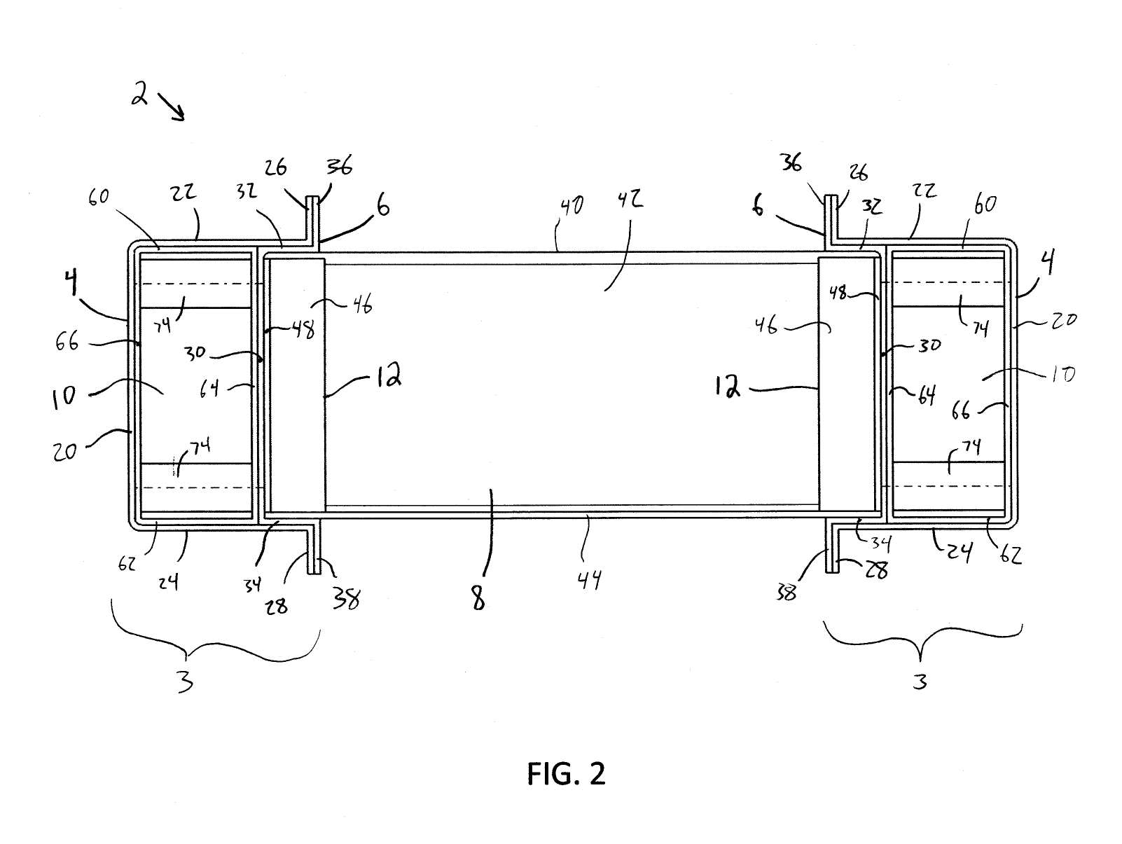

The inside rail sections 6 can be nested within the outside rail sections 4, as shown in FIGS. 1 and 2, to form the box frame rails 3 and define internal spaces between the side walls 20 and 30. To secure the inside rails 6 to the outside rails 4, upper surfaces of the top walls 32 can be bonded or otherwise coupled to lower surfaces of the top wall 22, and lower surfaces of the bottom walls 34 can be bonded or otherwise coupled to upper surfaces of the bottom walls 24. In addition, the top flanges 26 and 36 can be bonded or otherwise coupled together and the bottom flanges 28 and 38 can be bonded or otherwise coupled together to further secure the inside and outside rails together. The large flanges on the rails can provide for a large surface area for bonding or bolting, and results in increased torsional rigidity. The composite box sections 3 thus provide high beam bending and torsional resistance, comparable to conventional C-channel metal frame rails, while weighing much less. The internal spaces in the box sections 3 can also serve as protecting or shielding conduits to route wires, plumbing, and other conduits.

The frame 2 can comprise one or more, and desirably plural spaced apart crossmembers 8 that couple the box frame rails 3 together at different positions along the longitudinal length of the frame. Each crossmember 8 can comprise a top wall 40, two side walls 42 extending downwardly from the respective side edge portions of the top wall 40, and two bottom projections such as flanges 44 extending away from bottom edge portions of the side walls 42. The top and bottom flanges can be horizontal and the side wall flanges 42 can be vertical. In some embodiments, one or more of the crossmembers 8 can be oriented upside down from the orientation shown, such that the top wall 40 is at the bottom and the bottom flanges 44 are at the top. The crossmember 8 can thus also have a “hat” or U-shaped cross-section, similar to the shape of outside and inside rails 4, 6, which can provide increase torsional rigidity in the crossmember.

One end of each of the crossmembers 8 can be coupled to one of the frame rails 3 and the other end of each of the crossmembers 8 can be coupled to the other frame rails 3, as shown in FIGS. 1 and 2. At each end of the crossmember 8, an upper surface of the top wall 40 of the crossmember 8 can be bonded or otherwise coupled to a lower surface of the top wall 32 of the inside rail section 6. In addition, lower surfaces of the bottom flanges 44 of the crossmember can be bonded or otherwise coupled to upper surfaces of the bottom wall 34 of the inside rail 6.

End surfaces of the crossmember 8 can also be bonded or otherwise coupled to inner surfaces of the side walls 30 of the inside rail section 6. Brackets 12 can be used to couple the crossmembers 8 to the inside rail sections 6. The brackets 12 can comprise L-shaped or angle brackets comprising a base flange portion 48 and of a projecting flange portion 46 that extends away from the base flange portion. In the illustrated example, flanges 46, 48 are orthogonal to one another. Two of the brackets 12 can be used to couple an end of the crossmember 8 to the inner rail section 6, with one bracket 12 coupling each side wall 42 to the inner rail section 6. The flanges 46 of the bracket 12 can be bonded or otherwise coupled to the side walls 42 of the crossmember 8 and the side flanges 48 of the bracket 12 can be bonded or otherwise joined to the side walls 30 of the inner rails 6, thereby coupling the end crossmember 8 to the box sections 3. In addition, upper edge surfaces of the brackets 12 can be bonded or otherwise coupled to lower surfaces of the top walls 32 of the inner rail sections 6 and/or lower edge surfaces of the brackets 12 can be bonded or otherwise coupled to upper surfaces of the bottom walls 34 of the inner rails 6. In other embodiments, there can be spaces between the upper ends of the brackets 12 and the top walls 32 of the inner rail sections 6 and/or spaces between the bottom ends of the brackets 12 and the bottom walls 34 of the inner rail sections 6. Each end of the cross-members can be joined in the same manner by respective brackets to the proximate frame rail. The brackets 12 further provide increased strength in the high-stress areas where the crossmembers 8 are joined to the box sections 3.

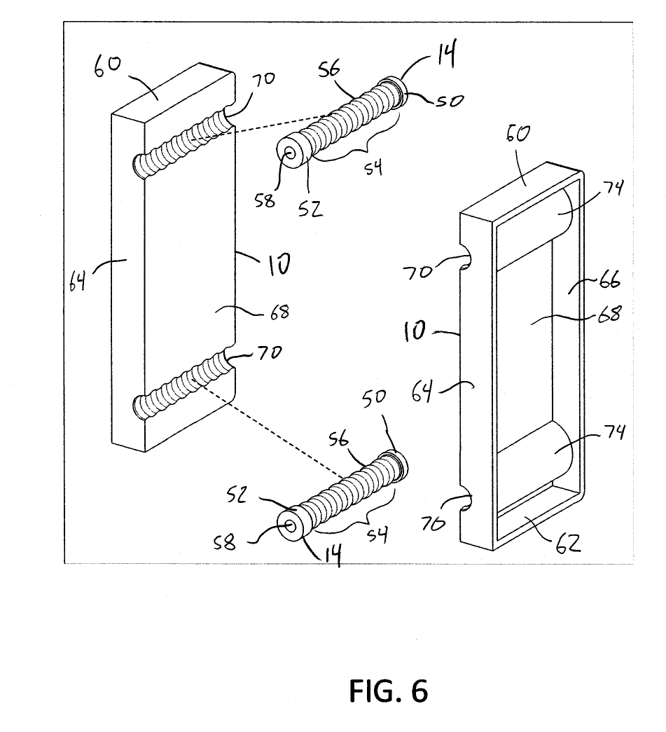

A plurality of supports 10, which can be comprised of composite material, can be positioned within the internal spaces of the frame rails 3 to provide increased structural support to the frame rails where they are coupled to crossmembers 8. The supports 10 make the box sections of the frame rails 3 more resistant to crushing under compressive loads when other components are bolted or otherwise attached to the box sections. The supports 10 can also support the inserts 14. The supports 10 can comprise first and second support portions, such as shown in FIG. 6, that cooperate to support the inserts 14. The first and second support portions that comprise a support can be substantially identical mirror images of each other. Each support portion can comprise a top wall 60, a bottom wall 62, an inner wall 64, and an outer wall 66 that are sized and shaped to match the internal dimensions of the box sections of the frame rails 3. When the support portions are installed, the top wall 60 can be bonded or coupled to the top wall 22 of the outside rail 4, the bottom wall 62 can be bonded or coupled to the bottom wall 24 of the outside rail 4, the outer wall 66 can be bonded to the side wall 20 of the outer rail 4, and the inner wall 64 can be bonded or coupled to the side wall 30 of the inside rail 6, as shown in FIG. 2. The support portions can also each comprise a facing wall 68 that is bonded or coupled to the facing wall of the other support portion of a pair of first and second support portions. Each support portion can comprise one or more cavities 70 in the facing wall 68 such that when the facing walls of two support portions are coupled together, the cavities 70 cooperate to form an opening extending through the support. The illustrated embodiments comprise two such cavities 70 per support portion, though other embodiments can comprise any number of cavities per support portion. The support portions 70 can further comprise reinforcement portions 74 around the cavities 70, as shown in FIG. 6.

The openings formed by adjoining pairs of the cavities 70 can be configured to surround and retain the inserts 14. The inserts 14 can comprise or consist of strong, durable materials, such as one or more of metal, composite, or polymer materials such as thermoset materials, as well as combinations thereof. In some embodiments, the inserts 14 can be made of a material that is stronger than the material of the supports 10 to provide added strength locally. The inserts can comprise an outer end portion 50, an inner end portion 52, and an intermediate portion 54. The intermediate portion 54 can comprise corrugations, ribs, or other features 56 that engage, such as mate or fit with, corresponding features in the cavities 70 to retain the inserts 14 in position against movement relative to the associated support, such as axial inward or outward movement relative to the associated support. In addition, the inner and outer end portions 50, 52 of the inserts 14 can have a greater diameter than the intermediate portion 56 to further restrict movement of the inserts 14 relative to the supports 70. The inserts 14 can be bonded or secured to the cavities 70. The corrugated or featured shape of the intermediate portion 54 provides an increased bonding surface area.

The inserts 14 desirably can have a generally cylindrical shape with a circular cross-section, as in the illustrated embodiment, but can have various other cross-sectional shapes in other embodiments, such as ovular, star-shaped, rectangular, triangular, or other non-circular cross-sectional shapes. The cavities 70 of the support portions can have a shape that matches the shape of the inserts 14.

The frame 2 can further comprise aligned holes in the various components through which the inserts 14 extend. For example, the outside rail sections 4 can comprise holes 80 in the side walls 20, the inside rail sections 6 can comprise holes 82 in the side walls 30, and the brackets 12 can comprise holes 84 in the side flanges 48. The holes 80, 82, and 84 can be formed with various processes, such as drilling or during manufacture of the frame rail sections. The holes 80, 82, 84 can be aligned with the cavities 70 in the supports 10 such that the inserts 14 can extend through the holes 80, 82, 84 as well as the supports 10. The outer end portions 50 of the inserts 14 can extend through the holes 80 in the outer rail 4. The outer end portions 50 can be flush with the outer surface of the side wall 20 of the outside rail 4. The inner end portions 52 can extend through the holes 82 in the inside rails 6 and through the holes 84 in the brackets 12. The inside end portions 52 can be flush with the inner surfaces of the side flanges 48 of the brackets 12.

The inserts 14 can further comprise an internal axially extending opening 58 extending entirely through the insert from the outer end portion 50 to the inner end portion 52. In this case, the inserts in effect comprise a tube that can be of metal. The internal openings 58 can serve various purposes. For example, the internal openings 58 can be threaded and serve as bolt holes, such as for attaching other components to the frame 2. The internal openings 58 can also serve as conduits for other objects to pass laterally through the box sections 3.

In some embodiments, bolts or other fasteners can be positioned through the internal openings 58 to clamp the brackets 12, inside rail sections 6, supports 10, and outside rail sections 4 together, either permanently or temporarily, such as until bonding together of the frame components is complete. As an example of bonding, an adhesive can be used to accomplish the bonding, less desirably, welding or bolting can be used.

The supports 10 and inserts 14 increase the strength of the frame rails 3 in bending, compression and torsion. The aligned combination of the crossmember 8 with the supports 10 and inserts 14 can support high lateral compressive loads on the frame.

With the possible exception of the inserts 14, which are desirably made of metal, the other components of the frame 2 can all be comprised of or consist entirely of composite materials, making the frame 2 lighter in weight compared to traditional metal frames. The composites used in the frame 2 can comprise any strong, lightweight composite or plurality of composites, such as fiber reinforced polymer composites. Examples of composite components include various fibers, resins, strengtheners, and other additives. Exemplary fibers include carbon fibers, glass fibers, aromatic polyamide fibers, such as Kevlar, and natural fibers, such as lignocellulosic fibers. Exemplary resins include phenolic resins, epoxies, polyesters, vinyl esters, polyetherketones, polyehterimides, polyethersulphone, high density polyethylenes, polycarbonates, acrylonitrile-butadiene-styrenes, polypropylene, nylon, and other thermoplastic and/or thermosetting polymers.

Several components of the frame 2, including the outside rail sections 4, inside rail sections 6, crossmembers 8, and brackets 12, can be manufactured using pultrusion processes, such as processes wherein unidirectional tows, woven mats, and/or other uncured composite materials are laid-up on a mandrel and pulled through a curing apparatus to form an elongated composite member having a generally constant cross-section. A more detailed description of exemplary fiber reinforced polymer materials and of exemplary pultrusion and related process, which can be used to manufacture components of the frame 2, can be found in U.S. Patent Application Publication No. US-2011-0204611-A1, entitled “Fiber Reinforced Polymer Frame Rail,” which was filed on Feb. 17, 2011, and which is herein incorporated by reference in its entirety.

### General Considerations

For purposes of this description, certain aspects, advantages, and novel features of the embodiments of this disclosure are described herein. The disclosed embodiments should not be construed as limiting in any way. Instead, the present disclosure is directed toward all novel and nonobvious features and aspects of the various disclosed embodiments, alone and in various combinations and sub-combinations with one another.

As used herein, including in the claims, the terms “left”, “right”, “front”, “rear”, “top” and “bottom” refer to conventional portions of a vehicle in which the described box frame is configured to be incorporated, from the perspective of a driver of the vehicle. Thus, the left side is the driver's side in the United States, the right side is the passenger's side in the United States, the bottom is the portion of the vehicle closest to the ground, the front end is the leading end of the vehicle when the vehicle is traveling forward and the rear end is the leading end when the vehicle is traveling in reverse. The term “frontward” means toward the front and the term “rearward” means toward the rear. The term “upper” means toward the top and term “lower” means toward the bottom. Similarly, the terms “inner,” “inside” and “inwardly” mean toward a longitudinally extending vertical center plane of the vehicle that divides the vehicle into left and right halves, and the terms “outer,” “outside” and “outwardly” mean away from the center plane and toward the left or right side of the vehicle.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means physically coupled or linked and does not exclude the presence of intermediate elements between the coupled items absent specific contrary language.

In view of the many possible embodiments to which the principles disclosed herein may be applied, it should be recognized that the illustrated embodiments are only preferred examples and should not be taken as limiting the scope of the invention. Rather, the scope of the invention is defined by the following claims. We therefore claim as our invention all that comes within the scope of these claims.

1. A frame for a vehicle having a front and a rear, the frame comprising:
a first elongated frame rail and a second elongated frame rail, each frame rail comprising composite material and comprising respective first and second elongated frame rail sections joined together to form a box beam frame rail comprising a box section that comprises an internal passageway extending in a front-to-rear direction; and
at least one crossmember comprising composite material and having a first end coupled to the first frame rail and a second end coupled to the second frame rail.

2. A frame for a vehicle having a front and a rear, the frame comprising:
a first elongated frame rail and a second elongated frame rail, each frame rail comprising composite material and comprising respective first and second elongated frame rail sections joined together to form a box beam frame rail comprising a box section that comprises an internal passageway extending in a front-to-rear direction; and
at least one crossmember comprising composite material and having a first end coupled to the first frame rail and a second end coupled to the second frame rail;
wherein the first and second frame rail sections comprise nested frame rail sections each with a base portion, first and second leg portions extending away from the base portion and first and second diverging end portions projecting from the end portions of the respective first and second leg portions spaced from the base portion, the leg portions of the first frame rail section being longer than the leg portions of the second frame rail portions, the second frame rail section being nestable within the first frame rail section such that the box section is provided between the base portion of the first frame rail section and the base portion of the second frame rail section.

3. The frame of claim 2, further comprising one or more supports positioned within the box section and bonded to internal surfaces of the rail sections that define the box sections.

4. The frame of claim 3, further comprising inserts supported by the supports within the box section, the inserts comprising metal tubes extending through the box sections and configured to receive fasteners.

5. The frame of claim 4, wherein the inserts comprise an intermediate portion that has exterior surface features that engage corresponding features of the supports to restrict the motion of the supports.

6. The frame of claim 1, wherein each of the frame rail sections are a hat-shaped cross-section with diverging end flange portions.

7. The frame of claim 6 wherein the crossmembers are of a hat-shaped cross-section and the first diverging end portion of the first frame rail is positioned adjacent to the first diverging end portion of the second frame rail and the second diverging end portion of the first frame rail is positioned adjacent to the second diverging end portion of the second frame rail.

8. The frame of claim 2, further comprising brackets, each bracket being bonded to the crossmember and to one of the frame rail sections.

9. A frame rail for a vehicle comprising:
first and second elongated frame rail sections, each frame rail section comprising a base portion, first and second leg portions extending away from the base portion and first and second diverging end portions projecting from the end portions of the respective first and second leg portions spaced from the base portion, the second frame rail section being nestable within the first frame rail section such that the box section is provided between the base portion of the first frame rail section and the base portion of the second frame rail section.

10. The frame of claim 9, further comprising one or more supports positioned within the box section and bonded to internal surfaces of the rail sections that define the box sections.

11. The frame of claim 10, further comprising inserts supported by the supports within the box section, the inserts comprising metal tubes extending through the box sections and configured to receive fasteners.

12. The frame of claim 11, wherein the inserts comprise an intermediate portion that has exterior surface features that engage corresponding features of the supports to restrict the motion of the supports.

13. The frame of claim 12, wherein the frame sections are a hat-shaped cross-section.

14. The frame of claim 9, wherein the frame sections are a hat-shaped cross-section.

15. A frame rail according to claim 9 wherein each of the first and second leg portions are perpendicular to the base portion and parallel to one another, and wherein the first diverging end portion is perpendicular to the first leg portion and the second diverging end portion is perpendicular to the second leg portion.

16. A frame rail according to claim 15 wherein the first end portion of the first rail portion abuts and is bonded to the first end portion of the second rail portion and wherein the second end portion of the first rail section abuts and is bonded to the second end portion of the second rail section.

17. A frame according to claim 1, wherein the frame rail sections are nested together, each of the first and second frame rail sections including a respective base, first and second legs extending at right angles from the base and having an end portion spaced from the base portion, a first flange portion extending outwardly at a right angle from the end portion of the first leg and a second flange portion extending outwardly at a right angle from the end portion of the second leg, the respective first flange portion of the first and second rail sections abutting one another and the second flange portions of the first and second rail sections abutting one another.
